(19) United States
(12) Patent Application Publication
(10) Pub. No.: US 2018/0223462 A1
(43) Pub. Date: Aug. 9, 2018

(54) PRIMARY HOMO STAPLE FIBER USING MELT-MODIFIED POLYESTER IN STAPLE FIBER FORM

(71) Applicant: Carver Non-Woven Technologies, LLC, Fremont, IN (US)

(72) Inventor: Garry E. Balthes, Elkhart, IN (US)

(21) Appl. No.: 15/889,198

(22) Filed: Feb. 5, 2018

Related U.S. Application Data
(60) Provisional application No. 62/455,393, filed on Feb. 6, 2017.

(51) Int. Cl. D04H 1/55; D01F 6/62; C08K 3/04; C08K 7/06; C08K 3/40; C08K 7/14; C08K 7/10; C08K 3/34; C08L 67/02; C08J 5/04

(52) U.S. Cl. CPC D04H 1/55; C08J 2467/02; C08K 3/04; C08K 7/06; C08K 3/40; C08K 7/14; C08K 7/10; C08K 3/34; C08L 67/02; C08J 5/042; C08J 5/043; C08J 5/044; C08J 5/045; C08J 5/046; C08L 2205/16; C08J 2300/00; C08J 2367/00; D01F 6/62

(57) ABSTRACT

A primary homo staple fiber including a melt-modified polyester component having a melt temperature in the range of 100 degrees Celsius to 260 degrees Celsius and configured in staple fiber form. Also, a non-woven composite article including a primary homo staple fiber including a melt-modified polyester component configured in staple fiber form and having melt temperature in the range of 100 degrees Celsius to 260 degrees Celsius. Also, a non-woven composite article including a non-woven composite material, the non-woven composite material including a fibrous first component of singular fibers of melt-modified polyester configured in a staple fiber form, and a fibrous second component including one or more fibers of various type, the fibrous first and second components are blended together, and the melt-modified polyester includes a low melting point polyethylene terephthalate (LPET) polyester as a primary binder in the non-woven composite material.

### CROSS-REFERENCE TO RELATED APPLICATION(S)

This application claims the benefit, under Title 35, U.S.C. § 119(e), of U.S. Provisional Patent Application Ser. No. 62/455,393 filed Feb. 6, 2017, entitled PRIMARY HOMO STAPLE FIBER USING MELT MODIFIED POLYESTER IN STAPLE FIBER FORM, the entire disclosure of which is incorporated herein by reference.

### BACKGROUND

The present invention relates to non-woven manufactured composite materials and, more particularly, to those utilizing polyester fibers.

The use of polypropylene has well been established as the preferred resin type used in manufactured non-woven composites as the primary binding resin used in conjunction with mineral, synthetic and cellulosic fibers. However, polypropylene has limited application as primary binder fibers due to limitations in its mechanical or heat deflection properties and therefore has had its market growth restricted by these limitations.

Moreover, polypropylene has issues relating to price, as its monomers have continuously risen in price while base stocks have declined in price due to closed-door pricing set by the few franking companies that make monomers for polypropylene. Polypropylene also has a dyne rate so low as to make it undesirable for painting. Polypropylene will also creep under load and hence has poor memory. Though it has a melt temperature of 171 degrees Celsius, polypropylene has a softening point of only 132 degrees Celsius, which has led, for example, to its failure in automobile underbody shield applications.

The other polymer of choice for use as a binding resin in non-woven manufactured composites is polyester. Polyester staple fibers can be used as the primary binding resin in non-woven applications but its uses with various fiber types have heretofore been restricted due to heating requirements higher than those required by polypropylene to bring the resin to melt temperature, and restrictions on existing capital equipment necessary to produce such processing temperatures.

Bi-component polyester fiber is also a widely-employed, general-use fiber that contains an inner core of either amorphous fiber, semi-crystalline fiber or full crystalline polyester fiber, surrounded by a co-extruded sheath of melt temperature-modified (also referred to herein as “melt-modified”) polyester fiber having melt temperatures that range from 110 degrees Celsius to the full melt temperature of pure polyester, which is 257 degrees Celsius.

A bi-component polyester fiber is made up of two parts: a core fiber which is of traditional polyester chemistry; and a co-extruded melt-modified polyester applied as outer adhesive layer having a melt temperature ranging from 110 degrees Celsius to 180 degrees Celsius. This product has been around for years and is commonly known as Bi—Co. Bi-component polyester fibers have melt temperatures in various ranges, with the most commonly used bi-component polyester fiber having a melt temperature of 110 degrees Celsius; the second most commonly used bi-component polyester fiber has a melt temperature of 180 degrees Celsius.

What is unique about bi-component polyester fiber is the chemically-modified melt temperature of the co-extruded sheath, which is used in a non-woven composite as the binding adhesive. The co-extruded sheath is made up of polyester resin having a conventional melt temperature of 226 degrees Celsius, and a melt temperature modifier that is added to the resin prior to extrusion of the bi-component polyester fiber. The amount of modifier added to the polyester resin depends on the desired range of melt temperatures, but commonly is twenty percent of the total sheath formulation. The maximum amount of modifier added to the polyester resin is approximately fifty percent of the total sheath formulation.

While the melt-modified chemistry is known and has been marketed as a hi-component fiber, the singular use of melt-modified polyester in staple fiber form is not heretofore known as the primary homo staple fiber. “Homo” is an industry term used to describe a single formulation of polymer for plastics, whereas the term “copolymer” is used to describe the use of more than one polymer formulation. “Staple fiber” is an industrial term used to identify fibers that are used in non-woven composites. Notably, a co-extruded sheath of melt-modified polyester fiber has never been produced into a single component melt-modified staple fiber and used as the primary and only polyester binder in a non-woven product. The use of such a heat-fusible, bicomponent filament as a staple fiber in a thermally bonded, wet lay fibrous web that defines a non-woven product, to not only increase the strength of the web but also avoid problems associated with separately adding binders, would represent a significant advancement in the relevant art.

### SUMMARY

Such an advancement is realized with the present invention, which utilizes the excellent melt and mechanical improvements of melt-modified polyester as the primary binder in non-woven products.

One embodiment of the present invention provides a primary homo staple fiber including a melt-modified polyester component having a melt temperature in the range of 100 degrees Celsius to 260 degrees Celsius and configured in staple fiber form.

In certain embodiments of the primary homo staple fiber, the melt-modified polyester component includes a low melting point polyethylene terephthalate (LPET) polyester fiber adapted for use as the primary binder in a non-woven composite formulation.

In certain embodiments of the primary homo staple fiber, the melt-modified polyester component defines a binder having a melt temperature in the range of 110 degrees Celsius to 227 degrees Celsius.

Certain embodiments of the primary homo staple fiber also include at least one material selected from the group consisting of glass fibers, carbon fibers, natural fibers, basalt fiber, synthetic non-melt fibers, polyester fibers, non-melt fibers, and high-temperature fibers. The selected material and the melt-modified polyester component are together configured in staple fiber form.

In certain embodiments of the primary homo staple fiber, a singular component fiber is defined by the melt-modified polyester component, and at least one of a glass fiber material, a carbon fiber material, a natural fiber material, a basalt fiber material, a synthetic non-melt fiber material, a polyester fiber material, a non-melt fiber material and a high-temperature fiber material.

Another embodiment of the present invention provides a non-woven composite article including a primary homo staple fiber. The primary homo staple fiber includes a melt-modified polyester component configured in staple fiber form and having melt temperature in the range of 100 degrees Celsius to 260 degrees Celsius.

In certain embodiments of the non-woven composite article, the melt-modified polyester component includes a low melting point polyethylene terephthalate (LPET) polyester fiber as the primary binder in the non-woven composite formulation.

In certain embodiments of the non-woven composite article, the melt-modified polyester component defines a binder having a melt temperature in the range of 110 degrees Celsius to 227 degrees Celsius.

Certain embodiments of the non-woven composite article also include at least one material selected from the group consisting of glass fibers, carbon fibers, natural fibers, basalt fiber, synthetic non-melt fibers, polyester fibers, non-melt fibers, and high-temperature fibers. In some such embodiments, the selected material and the melt-modified polyester component are together configured in staple fiber form.

In certain embodiments of the non-woven composite article, a singular component fiber is defined by the melt-modified polyester component, and at least one of a glass fiber material, a carbon fiber material, a natural fiber material, a basalt fiber material, a synthetic non-melt fiber material, a polyester fiber material, a non-melt fiber material and a high-temperature fiber material.

Another embodiment of the present invention provides a non-woven composite material including a fibrous first component of singular fibers of melt-modified polyester configured in a staple fiber form, and a fibrous second component. The fibrous second component includes fibers of at least one fiber type selected from the group consisting of: glass fibers, carbon fibers, natural fibers, basalt fibers, synthetic non-melt fibers, polyester fibers, non-melt fibers, and high-temperature fibers. The fibrous first and second components are blended together, and the melt-modified polyester includes a low melting point polyethylene terephthalate (LPET) polyester that is a primary binder in the non-woven composite material.

In certain embodiments of the non-woven composite material, the singular component fiber defines a binder having a melt temperature range of 110 degrees Celsius to 227 degrees Celsius.

### DETAILED DESCRIPTION OF THE EXEMPLARY EMBODIMENT(S)

This invention was designed to find a replacement for polypropylene for the reasons of improving heat stability, tensile strength and flex stiffness, as well as providing a compatible surface for adhesive application through improving surface dyne rate.

Improved mechanical strength performance relative to polypropylene or bi-component polyester is achievable in a material according to the present disclosure, which can objectively improve opportunities for weight reduction in automotive and other applications.

In certain embodiments according to the present invention, the utilization of polyester fiber is expected to provide significant cost reductions relative to prior materials utilizing polypropylene fiber, the current cost of which is approximately $1.02 per pound. In comparison, LPET polyester fiber currently costs about $0.73 per lb. Further cost reductions relative to prior materials are also expected in connection with anticipated weight savings facilitated by materials according to the present invention, the performance indicators of which show improvement relative to those of comparable prior materials.

In a composite material according to the present disclosure, a co-extruded, modified-melt temperature polyester is used as the primary adhesive. The material may include a singular component fiber using a melt-modified polyester, such as an LPET polyester fiber, used as the primary binder and, in certain formulations, serving as direct replacement for polypropylene.

According to the present invention, manufactured non-woven products include but are not limited to composites containing any types of non-melt fiber types, such as glass fibers, carbon fibers, natural fibers, basalt fibers, polyester fibers, synthetic non-melt fibers, non-melt fibers, and high-temperature fibers, either singularly or in various combinations with each other. In the context of the present disclosure, “high-temperature fibers” are defined as a fiber type capable of being formulated to selectively melt in a range extending from a minimum melt temperature of 110 degrees Celsius, to a maximum melt temperature of about 240 degrees Celsius, in 10 degrees Celsius unit increments.

Additionally, the composite material includes a singular melt-modified polyester fiber component, with low melting point polyethylene terephthalate (LPET) polyester fiber used as the primary binder. The melt-modified polyester fiber component is configured in a staple fiber form, and has a melt-modified polyester component with a temperature melt range of 100 degrees Celsius to 260 degrees Celsius.

A material according to the present disclosure also provides improved surface dyne rate over polypropylene, thereby allowing parts to be paintable without need of adhesive promoter, and improved bonding strengths across variety of non-melt fibers, thereby obviating the need for special additives necessary to enhance the bonding properties of polypropylene. Relative to polypropylene, a composite material according to the present disclosure improves surface dyne rate, thus allowing parts to be paintable without need of adhesive promoter, and improves bonding strengths across variety of non-melt fibers without the need for special additives to enhance bonding properties.

The dyne rate of the surface energy or adhesive compatibility of a polymer is described as follows. The term dyne rate is used in the plastics and adhesive industry to measure polymer surface energy adhesion capability. The test to determine dyne rate is conducted by using a dyne test pen. As known to those having ordinary skill in the relevant art, dyne test pens are used to help measure surface tension to determine proper adhesion compatibility between ink solutions, coatings and substrates. A dyne test pen is similar to an ordinary pen used as a writing instruments, but applies a solution of a known surface tension capability that reacts differently under various surface tension levels.

A dyne test pen set includes a plurality of such pens that apply solutions having dyne rates ranging from 20 up to 50. When a test analyst draws the dyne test pen across the surface of a subject polymer material, the pen deposits the liquid solution on the surface. If the drawn line of liquid is broken or clumpy, the analyst would then apply another line using a pen of lower dyne rate solution, and repeat as necessary with the goal of obtaining a uniform application of liquid solution that does not change shape after application to the polymer material surface. The rating of the dyne test pen used to achieve this goal is then used to describe the dyne rate of the subject polymer material surface.

A dyne rate of 37 or higher is required for a surface to have compatible bonding capability with most adhesives or paints. Polypropylene has a very low dyne rate of 29, which renders it incapable of forming a bond with most adhesives. The very few adhesives capable of bonding with polypropylene are very expensive. Polyester, on the other hand, has a medium dyne rate of 43, and is capable of bonding with most hot melt and liquid polyurethane adhesives. In some embodiments of a non-woven product according to the present invention, the surface dyne rate is 44 to 45.

A material according to the present disclosure provides broad application of a single resin by facilitating the customization of the design binder melt temperature, to a value between from 110 degrees Celsius to 227 degrees Celsius in 5 degree Celsius unit increments, thereby affording a better fit between binder technology and composite product application requirements. In other words, broader application of a single resin is facilitated by the ability to custom design binder melt temperature from 110 degrees Celsius to 227 degrees Celsius in 5 degree Celsius increments, whereby a better fit between binder technology and end product application requirements can be realized. The primary homo staple fiber using melt modified polyester component in a staple fiber form, has a melt-modified polyester component with broad temperature melt range of 100 degrees Celsius to 260 degrees Celsius.

The capabilities of manufacturers to apply any new resin technology within their current manufacturing systems must also be considered. Since the melt temperature of polypropylene is 171 degrees Celsius, it is important in the industry that any alternative polymer can be processed within similar temperature ranges as well as using same equipment. The focus therefore of this embodiment is to use heat modified polyester as a copolymer staple fiber with full melt capability as direct replacement for polypropylene.

To alter the melt temperature of an LPET polyester fiber, two additional chemicals known as chemical packs are added to the polyester resin flow in extruders. According to one embodiment, these chemical packs are composed of isophtholic acid and cyclohexane dimethanol. The percent of each chemical pack added to the polyester alters its melt temperature. Polyester has a full melt temperature of 254 degrees Celsius, and can be reduced to as low as 100 degrees Celsius with additional of the chemical packs.

In certain embodiments, the present disclosure provides an extruded single component melt modified polyester, using LPET as the only binding synthetic fiber, in combinations of blends including glass, carbon and natural fiber. For example, LPET wets and bonds significantly better to glass, carbon, natural and similar other fiber types than does polypropylene. Relative to polypropylene, LPET has a higher softening point and is much more stable as a polymer in a blended matrix.

The primary homo staple fiber ideally incorporates an LPET polyester fiber as the melt modified polyester configured in a staple fiber form. Melt modified LPET is adapted for use as a primary binder and/or the sole binding fiber adhesive in the non-woven composite article.

This melt modified polyester component blends with at least one or more singular fiber component(s) or a combination of a fiber type component of any of the following materials, glass fibers, carbon fibers, natural fibers, basalt fiber, synthetic non-melt fibers, polyester fibers, non-melt fibers, high-temperature fibers, or any similar like fiber.

For example, in an embodiment according to the present disclosure, melt-modified LPET, a singular melt-modified polyester further component, is blended with glass fibers, carbon fibers, natural fibers, basalt fiber, synthetic non-melt fibers, polyester fibers, non-melt fibers, high-temperature fibers, any similar fiber, or a mixture thereof. Each blended ratio of the melt-modified LPET fiber any other fiber type(s) may range from 80/20 to 20/80 as percent by weight. Weight is only relative in building application weight, not a composite mix rate. For example, 80 percent natural fiber and 20 percent LPET fiber in a 100 gsm web in basis weight would convert to 80 grams of natural fiber and 20 grams of LPET fiber. Ostensibly, the percent by weight would be approximately 50/50, equal weights. However, the range could span from 80/20 to 20/80 percent by weight. Preferably at least one fiber is the melt-modified LPET polyester fiber, which forms the singular melt-modified polyester component. The resulting blended fiber will be configured in a staple fiber form.

Regarding bonding properties in non-woven composites, polypropylene relies mostly on mechanical bonding when melted to composite non-woven containing glass or other similar fiber types. In order to achieve chemical bonding, the use of maleic anhydride acid is preferably included in resin formulation during fiber extrusion. Polyester resin does not require any additional additives to bond with glass and other fiber types including carbon and natural fiber. Therefore, using this resin in formulation provides both chemical as well as mechanical bonding. All preliminary testing done has shown an improvement in flexural modulus of twenty percent of the same formulation of material blend of same weight and same fiber ratio with only LPET substituting with polypropylene resin.

Pretesting of molded samples of carbon/LPET polyester fiber blends has demonstrated outstanding performance. Similar results are anticipated with blends containing either glass or natural fiber, as these fiber types tend to bond with polyester better than with polypropylene. A composite material according to the present disclosure provides improved mechanical strength performance in comparison to polypropylene or bi-component polyester, objectively improves opportunities for lighter weight composite components in automotive and other applications, and presents opportunities for reducing the costs of composite components either by lowering the cost of raw materials, or by cost reductions achieved through weight savings afforded by increases in composite material performance values.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A primary homo staple fiber comprising:
a melt-modified polyester component, wherein the melt-modified polyester component has a melt temperature in the range of 100 degrees Celsius to 260 degrees Celsius;
wherein the melt-modified polyester component is configured in staple fiber form.

2. The primary homo staple fiber of claim 1, wherein the melt-modified polyester component comprises a low melting point polyethylene terephthalate (LPET) polyester fiber adapted for use as the primary binder in a non-woven composite formulation.

3. The primary homo staple fiber of claim 1, wherein the melt-modified polyester component defines a binder having a melt temperature in the range of 110 degrees Celsius to 227 degrees Celsius.

4. The primary homo staple fiber of claim 1, further comprising:
at least one material selected from the group consisting of glass fibers, carbon fibers, natural fibers, basalt fiber, synthetic non-melt fibers, polyester fibers, non-melt fibers, and high-temperature fibers;
wherein the selected material and the melt-modified polyester component are together configured in staple fiber form.

5. The primary homo staple fiber of claim 1, wherein a singular component fiber is defined by the melt-modified polyester component, and at least one of a glass fiber material, a carbon fiber material, a natural fiber material, a basalt fiber material, a synthetic non-melt fiber material, a polyester fiber material, a non-melt fiber material and a high-temperature fiber material.

6. A non-woven composite article comprising:
a primary homo staple fiber comprising a melt-modified polyester component configured in staple fiber form and having melt temperature in the range of 100 degrees Celsius to 260 degrees Celsius.

7. The non-woven composite article of claim 6, wherein the melt-modified polyester component comprises a low melting point polyethylene terephthalate (LPET) polyester fiber as the primary binder in the non-woven composite formulation.

8. The non-woven composite article of claim 6, wherein the melt-modified polyester component defines a binder having a melt temperature in the range of 110 degrees Celsius to 227 degrees Celsius.

9. The non-woven composite article of claim 6, further comprising:
at least one material selected from the group consisting of glass fibers, carbon fibers, natural fibers, basalt fiber, synthetic non-melt fibers, polyester fibers, non-melt fibers, and high-temperature fibers.

10. The non-woven composite article of claim 9, wherein the selected material and the melt-modified polyester component are together configured in staple fiber form.

11. The non-woven composite article of claim 6, wherein a singular component fiber is defined by the melt-modified polyester component, and at least one of a glass fiber material, a carbon fiber material, a natural fiber material, a basalt fiber material, a synthetic non-melt fiber material, a polyester fiber material, a non-melt fiber material and a high-temperature fiber material.

12. A non-woven composite article comprising:
a non-woven composite material, the non-woven composite material comprising:
a fibrous first component of singular fibers of melt-modified polyester configured in a staple fiber form, and
a fibrous second component comprising fibers of at least one fiber type selected from the group consisting of: glass fibers, carbon fibers, natural fibers, basalt fibers, synthetic non-melt fibers, polyester fibers, non-melt fibers, and high-temperature fibers;
wherein the fibrous first and second components are blended together; and
wherein the melt-modified polyester comprises a low melting point polyethylene terephthalate (LPET) polyester, and is a primary binder in the non-woven composite material.

13. The article of claim 12, wherein the singular component fiber defines a binder having a melt temperature range of 110 degrees Celsius to 227 degrees Celsius.
